(19) United States
(12) Patent Application Publication
(10) Pub. No.: US 2019/0279011 A1
(43) Pub. Date: Sep. 12, 2019

(54) DATA ANONYMIZATION USING NEURAL NETWORKS

(71) Applicant: MICROSOFT TECHNOLOGY LICENSING, LLC, Redmond, WA (US)

(72) Inventors: KAMLESH DATTARAM KSHIRSAGAR, STUTTGART (DE); FRANK T. SEIDE, YARROW POINT, WA (US)

(21) Appl. No.: 15/918,736

(22) Filed: Mar. 12, 2018

(51) Int. Cl. G06K 9/00; G06N 3/08; G06N 3/04; G06K 9/62

(52) U.S. Cl. CPC G06K 9/00979; G06K 9/6256; G06N 3/04; G06N 3/08

(57) ABSTRACT

The technology described herein anonymizes images using a bifurcated neural network. The bifurcated neural network can comprise two portions with a local portion running on a local computer system and a remote portion running in a data center that is connected to the local computer system by a computer network. Together, the local portion and the remote portion form a complete neural network able to classify images, while the image never leaves the local computer system. In aspects of the technology, the local portion of the neural network receives a local image and creates a transformed object. The transformed object is communicated to the remote portion of the bifurcated neural network in the data center for classification.

### BACKGROUND

Technology exists for computers to classify images. Generally, a computer classifier is trained using training labeled image data. The label for each image corresponds to an object in the image. Conceptually, the training data is input to the model, which makes adjustments to nodes within the model until the predicted outcome from the model matches the label. Once trained, the image classifier can assign a label to an unlabeled image.

### SUMMARY

This summary is provided to introduce a selection of concepts in a simplified form that are further described below in the detailed description. This summary is not intended to identify key features or essential features of the claimed subject matter, nor is it intended to be used in isolation as an aid in determining the scope of the claimed subject matter.

The technology described herein anonymizes images using a bifurcated neural network. The bifurcated neural network can comprise two portions with a local portion running on a local computer system and a remote portion running in a data center that is connected to the local computer system by a computer network. Together, the local portion and the remote portion form a complete neural network able to classify images, while the image never leaves the local computer system.

The technology improves the data security of computing systems, especially distributed computing systems, by avoiding a need to transmit an image. The technology can be combined with encryption and other security mechanisms designed to secure data during a communication process or storage. For example, a transformed object, from which the image cannot be reproduced, could be encrypted prior to communication from a local computing system to a remote computing system for further processing. Existing encryption and denial of access technology often provides a suitable level of data security, but the present technology can add an extra layer of protection for remote processing of image data.

In aspects of the technology, the local portion of the neural network receives a local image and creates a transformed object. The transformed object effectively anonymizes the original image because the image cannot be reproduced with certainty from the transformed object. The transformed object is communicated to the remote portion of the bifurcated neural network in the data center for classification. In order to take the transformed object as input, the transformed object follows a schema suitable for input into the remote portion of the network. Different types of classification models may require different schemas and each layer of a model may have a unique schema.

### DRAWINGS

Aspects of the technology described herein are described in detail below with reference to the attached drawing figures, wherein:

FIG. 1 is a block diagram of an example operating environment suitable for implementing aspects of the technology described herein;

FIG. 2 is a diagram depicting an example computing architecture suitable for implementing aspects of the technology described herein;

FIG. 3 is a diagram depicting an analogously trained model, in accordance with an aspect of the technology described herein;

FIG. 4 is a diagram depicting training of a remote machine classifier using anonymized image data, in accordance with an aspect of the technology described herein;

FIG. 5 is a diagram depicting training of a remote machine classifier using anonymized image data, in accordance with an aspect of the technology described herein;

FIG. 6 is a diagram depicting training of a remote machine classifier using anonymized image data, in accordance with an aspect of the technology described herein;

FIG. 7 is a diagram depicting classification of an image using a remote machine classifier that processes anonymized image data, in accordance with an aspect of the technology described herein;

FIG. 8 depicts a flow diagram of a method for anonymizing image data, in accordance with an aspect of the technology described herein;

FIG. 9 depicts a flow diagram of a method for anonymizing image data, in accordance with an aspect of the technology described herein;

FIG. 10 depicts a flow diagram of a method for anonymizing image data, in accordance with an aspect of the technology described herein; and

FIG. 11 is a block diagram of an exemplary computing environment suitable for use in implementing an aspect of the technology described herein.

### DETAILED DESCRIPTION

The subject matter of aspects of the technology described herein is described with specificity herein to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

The technology described herein anonymizes images using a bifurcated neural network. The bifurcated neural network can comprise two portions with a local portion running on a local computer system and a remote portion running in a data center that is connected to the local computer system by a computer network, such as the Internet. Together, the local portion and the remote portion form a complete neural network able to classify images, while the image never leaves the local computer system.

The technology improves the data security of computing systems, especially distributed computing systems, by avoiding a need to transmit an image. The technology can be combined with encryption and other security mechanisms designed to secure data during a communication process or storage. For example, a transformed object, from which the image cannot be reproduced, could be encrypted prior to communication from a local computing system to a remote computing system for further processing. Existing encryption and denial of access technology often provides a suitable level of data security, but the present technology can add an extra layer of protection for remote processing of image data.

As used herein, a neural network comprises at least three operational layers. The three layers can include an input layer, a hidden layer, and an output layer. Each layer comprises neurons. The input layer neurons pass data to neurons in the hidden layer. Neurons in the hidden layer pass data to neurons in the output layer. The output layer then produces a classification. Different types of layers and networks connect neurons in different ways.

Every neuron has weights, an activation function that defines the output of the neuron given an input (including the weights), and an output. The weights are the adjustable parameters that cause a network to produce a correct output. The weights are adjusted during training. Once trained, the weight associated with a given neuron can remain fixed. The other data passing between neurons can change in response to a given input (e.g., image).

The neural network may include many more than three layers. Neural networks with more than one hidden layer may be called deep neural networks. Example neural networks that may be used with aspects of the technology described herein include, but are not limited to, multilayer perceptron (MLP) networks, convolutional neural networks (CNN), recursive neural networks, recurrent neural networks, and long short-term memory (LSTM) (which is a type of recursive neural network). The implementation described herein in association with the Figures uses a convolutional neural network, but aspects of the technology are applicable to other types of multi-layer machine classification technology.

In aspects of the technology, the local portion of the neural network receives a local image and creates a transformed object. The transformed object effectively anonymizes the original image because the image cannot be reproduced with certainty from the transformed object. The transformed object may then be communicated to the remote portion in the data center for classification. In order to take the transformed object as input, the transformed object follows a schema suitable for input into the remote portion of the classification model. Different models may require different schemas, and each layer of a model may have a unique schema.

As used herein, a transformed object represents the output of neurons in a single neural network layer. Each output in the transformed object may be associated within the transformed object to a neuron that generated the output. In this way, the receiving layer (or an intermediary component) in the remote portion of the network can map outputs in the transformed object to the correct neurons in the receiving layer. Beyond feeding the correct data to neurons in the receiving layer, the identification of the source neuron can itself be an input to a calculation done by a neuron in a receiving layer. For example, if the receiving layer is a fully-connected layer where the output of each neuron in the preceding layer is input to each neuron in the receiving layer, then the source of the neuron producing each output can be part of the input.

Aspects of the technology described herein can use a bifurcated process to train the bifurcated neural network to avoid a need to transmit training data from the local computing system to the remote system. Initially, a complete neural network can be trained in a data center using analogous training data. This model may be described herein as an analogous model. For example, if a goal of the completed bifurcated neural network is to identify certain people through facial recognition, then the analogous model could be trained on facial recognition databases. This should allow the model to develop weights that recognize relevant facial features for recognition.

The analogous model is then split and the preliminary portion communicated to the local computing system. Labeled training images from the local computing system are then fed to the preliminary portion of the model and used to generate a transformed object. The transformed object and the label associated with the image are then communicated to the data center to train the remote portion of the bifurcated neural network. For example, if the goal is to train the model to recognize certain individuals in images, then images of those individuals are processed by the preliminary portion to generate a transformed object that is communicated to the data center. Identification information (e.g., labels) for the individuals depicted in an image that resulted in the transformed object are communicated with the transformed object.

Once trained, unlabeled images can be processed by the preliminary portion of the model locally, and then communicated to the data center for processing and ultimate label assignment by the remote portion. The classification is then communicated back to the local portion.

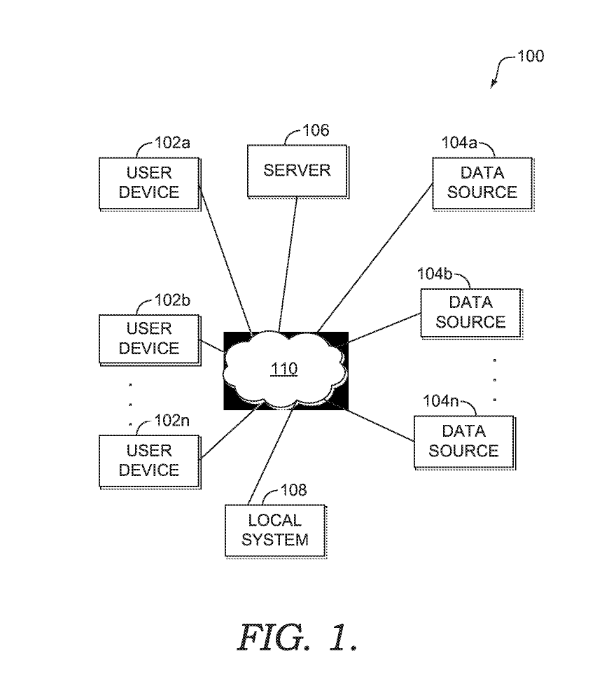

Turning now to FIG. 1, a block diagram is provided showing an example operating environment 100 in which some aspects of the present disclosure may be employed. It should be understood that this and other arrangements described herein are set forth only as examples. Other arrangements and elements (e.g., machines, interfaces, functions, orders, and groupings of functions, etc.) can be used in addition to or instead of those shown, and some elements may be omitted altogether for the sake of clarity. Further, many of the elements described herein are functional entities that may be implemented as discrete or distributed components or in conjunction with other components, and in any suitable combination and location. Various functions described herein as being performed by one or more entities may be carried out by hardware, firmware, and/or software. For instance, some functions may be carried out by a processor executing instructions stored in memory.

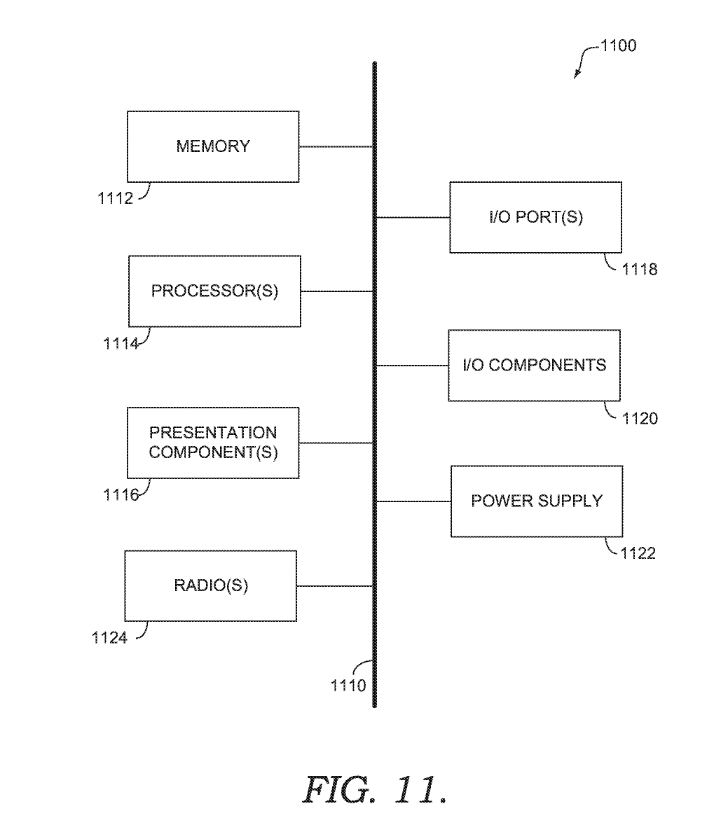

Among other components not shown, example operating environment 100 includes a number of user devices, such as user devices 102a and 102b through 102n; a number of data sources, such as data sources 104a and 104b through 104n; local computing system 108; remote server 106; and network 110. It should be understood that environment 100 shown in FIG. 1 is an example of one suitable operating environment. Each of the components shown in FIG. 1 may be implemented via any type of computing device, such as computing device 1100 described in connection to FIG. 11. These components may communicate with each other via network 110, which may include, without limitation, one or more local area networks (LANs) and/or wide area networks (WANs). In exemplary implementations, network 110 comprises the Internet and/or a cellular network, amongst any of a variety of possible public and/or private networks.

User devices 102a and 102b through 102n can be client devices on the client-side of operating environment 100, while server 106 can be on the server-side of operating environment 100. The user devices can send and receive communications including images, generate images, and store images. These images can be transferred to a data store 104, which may be a local data store. The user devices 102 can generate user interfaces that are used to control other components, including server 106 components and local computing system 108 components. The user device 102 can be a source of user information, such as a location information (e.g., GPS), calendar information, communication information, and other metadata that may be processed with images, in some aspects.

Server 106 can comprise server-side software designed to work in conjunction with client-side software on user devices 102a and 102b through 102n and local computing system 108 so as to implement any combination of the features and functionalities discussed in the present disclosure. For example, the server 106 may run a classifier, such as remote system 280, which classifies images based on transformed objects received from a local neural network portion running on the local computing system 108. The server 106 may operate in a data center and comprise multiple hardware devices for operating the model, including a plurality of graphics processing units (GPU), which may be described as a GPU farm. This division of operating environment 100 is provided to illustrate one example of a suitable environment, and there is no requirement for each implementation that any combination of server 106 and user devices 102a and 102b through 102n remain as separate entities.

User devices 102a and 102b through 102n may comprise any type of computing device capable of use by a user. For example, in one aspect, user devices 102a through 102n may be the type of computing device described in relation to FIG. 11 herein. By way of example and not limitation, a user device may be embodied as a personal computer (PC), a laptop computer, a mobile or mobile device, a smartphone, a tablet computer, a smart watch, a wearable computer, a virtual reality headset, augmented reality glasses, a personal digital assistant (PDA), an MP3 player, a global positioning system (GPS) or device, a video player, a handheld communications device, a gaming device or system, an entertainment system, a vehicle computer system, an embedded system controller, a remote control, an appliance, a consumer electronic device, a workstation, or any combination of these delineated devices, or any other suitable device.

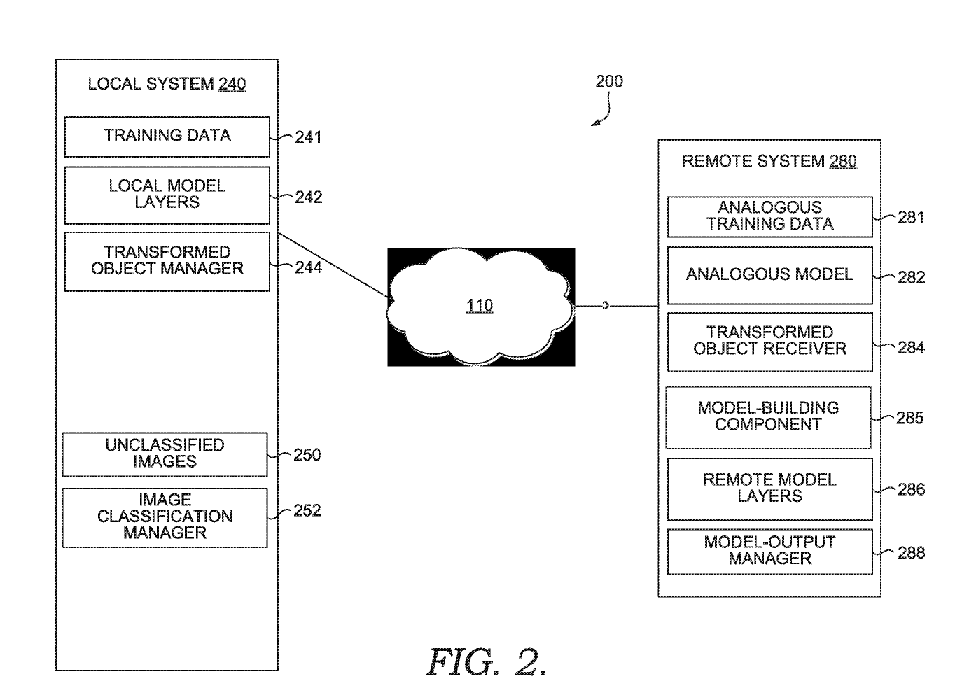

Data sources 104a and 104b through 104n may comprise data sources and/or data systems, which are configured to make data available to any of the various constituents of operating environment 100, or system 200 described in connection to FIG. 2. (For example, in one aspect, one or more data sources 104a through 104n provide (or make available for accessing) images to the local computing system 240 of FIG. 2.) Data sources 104a and 104b through 104n may be discrete from user devices 102a and 102b through 102n and server 106 or may be incorporated and/or integrated into at least one of those components.

Local computing system 108 may provide resources to run local computing system 240. The local computing system 108 may be associated with a single entity such as a business or government agency. The data sources 104a through 104n can include local data sources associated with the local computing system 108.

Operating environment 100 can be utilized to implement one or more of the components of system 200, described in FIG. 2.

Referring now to FIG. 2, with FIG. 1, a block diagram is provided showing aspects of an example computing system architecture suitable for implementing an aspect of the technology described herein and designated generally as system 200. System 200 represents only one example of a suitable computing system architecture. Other arrangements and elements can be used in addition to or instead of those shown, and some elements may be omitted altogether for the sake of clarity. Further, as with operating environment 100, many of the elements described herein are functional entities that may be implemented as discrete or distributed components or in conjunction with other components, and in any suitable combination and location.

Example system 200 includes network 110, which is described in connection to FIG. 1, and which communicatively couples components of system 200 including local system 240 and remote system 280. Remote system 280 (including its components 281, 282, 284, 285, 286, and 288) and local system 240 (including its components 241, 242, 244, 250, and 252) may be embodied as a set of compiled computer instructions or functions, program modules, computer software services, or an arrangement of processes carried out on one or more computer systems, such as computing device 1100 described in connection to FIG. 11.

Moreover, these components, functions performed by these components, or services carried out by these components may be implemented at appropriate abstraction layer(s), such as the operating system layer, application layer, hardware layer, etc., of the computing system(s). Alternatively, or in addition, the functionality of these components and/or the aspects of the technology described herein can be performed, at least in part, by one or more hardware logic components. For example, and without limitation, illustrative types of hardware logic components that can be used include Field-programmable Gate Arrays (FPGAs), Application-specific Integrated Circuits (ASICs), Application-specific Standard Products (ASSPs), System-on-a-chip systems (SOCs), Complex Programmable Logic Devices (CPLDs), etc. Additionally, although functionality is described herein regarding specific components shown in example system 200, it is contemplated that in some aspects functionality of these components can be shared or distributed across other components.

The local system 240 generates a transformed object by processing an image with a local portion of a bifurcated neural network. The local system 240 comprises training data 241, local model layers 242, transformed object manager 244, unclassified images 250, and image classification manager 252.

The training data 241 comprises labeled images. The label corresponds to an object and/or characteristics of the object visibly depicted in the image. For example, an image of a cat could be labeled with a “cat” tag. Characteristics of the cat could include a cat breed, hair color, hair length, size, or activity. All of these characteristics could form separate labels for an image. Thus, an image can have multiple labels. The labels can be assigned by a human viewing the image. An image with multiple objects can have individual objects labeled. These labels can identify an area of the image that depicts the object associated with the label. As explained in more detail, the training data 241 is used to train a neural network to recognize similar objects in unclassified images. For example, images of a cat can be used to train the bifurcated neural network to recognize cats in other images.

The local model layers 242 include an input layer and optionally one or more additional layers of a neural network trained to classify images. The input layer receives an image and generates an output that is mapped to a subsequent layer. The output of the input layer is an example of a transformed object. The subsequent layer similarly generates an output, which may also be described herein as a transformed object.

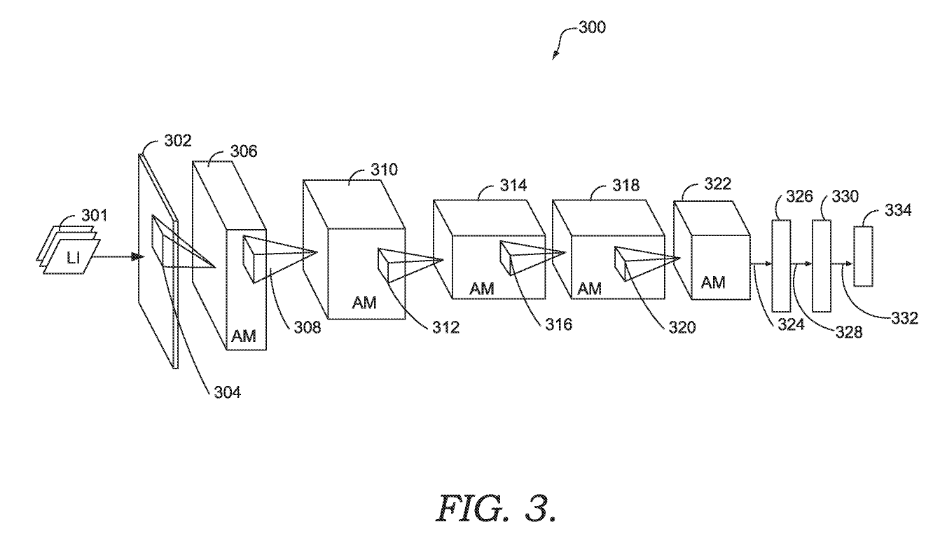

The local model layers 242 can be trained remotely in a data center using analogous training data. For example, if an entity wishes to keep its database of labeled cat images on a local system, a publicly available database of cat images can be used as analogous training data to train an analogous model, such as analogous model 300, shown in FIG. 3. A first subset of layers from the analogous model can be transferred to the local computing system. The subset of layers can constitute the local model layers 242. Note, in this example, the training data 241 is not used to train the local model layers. The local model layers 242 can be used to generate transformed objects that are used to remote model layers 286.

The transformed object manager 244 communicates transformed objects to the remote system 280. The transformed object manager 244 can also communicate image labels with the transformed objects. When training data is processed by the local model layers 242, then labels associated with the images used to generate the transformed objects are also communicated to the remote system 280.

The transformed object manager 244 may assign identifications to a transformed object. The identification can be used by the image classification manager 252 to associate a label provided by the remote system 280 with an unclassified image. For example, a transformed object may be generated from an image by the local model layers 242. The transformed object can be associated with an identification that can be used to associate the transformed object with the image used to generate it. The transformed object may be communicated from the transformed object manager 244 to the remote system 280 along with identification information for the transformed object. Upon generating a classification using the transformed object as input, the remote system 280 can communicate the classification along with the identification to the image classification manager 252. The image classification manager 252 can then use the identification information to associate the provided classification with the image.

The unclassified images 250 are a collection of images to be classified by the combined efforts of the local system 240 in the remote system 280. The unclassified images 250 are fed to the local model layers 242 and used to generate transformed objects. The transformed objects are communicated from the transformed object manager 244 to the transformed object receiver 284. The transformed objects are then input to the remote model layers 286. The remote model layers 286 assign a classification using the transformed object as input. The classification may be communicated back to the image classification manager 252 and associated with the image that was used to generate the associated transformed object.

The image classification manager 252 receives classification information from the remote system 280. The image classification manager 252 then associates that classification with an image that was used to generate the transformed object processed by the remote system 280 to generate the classification.

The remote system 280 assigns a classification to an image by taking the transformed object received from the local system 240 as input. The remote system 280 comprises analogous training data 281, analogous model 282, transformed object receiver 284, model-building component 285, remote model layers 286, and model output manager 288.

The analogous training data 281 is used to train the analogous model. As mentioned, the goal of the technology described herein is to maintain images on the local computing system, rather than transferring them to a data center for processing. This means that training data 241 is not transferred to the remote system 280 to train a neural network. The analogous training data 281 comprises labeled images of subject matter that is analogous to the subject matter in images that will ultimately be classified. Generally, a neural network starts with random values assigned as preliminary weight values for each node. During training, the network recalculates these values as different image features prove to have more value in predicting a classification. Accordingly, the weights assigned by the analogous model using the analogous training data provide reasonable weights for use classifying similar images.

The analogous model 282 is a full multilayer classification model (e.g., neural network) trained using the analogous training data 281. As mentioned, the training can change the weights of each node in the model from an initial value to a value that provides the most accurate image predictions. The analogous model can be trained by the model-building component 285. The analogous model 282 can include all of the same layers used in the working bifurcated neural network. Once trained, a first subset of layers (e.g., the first layer, the first and second layer) can be communicated to the local system 240 to serve as the local model layers 242.

Transformed object receiver 284 receives transformed objects from the transformed object manager 244. The transformed object receiver 284 then communicates the transformed objects to the remote model layers 286 for processing.

Model-building component 285 builds both the analogous model 282 and the remote model layers 286. The model-building component 285 trains the analogous model 282 using the analogous training data 281. The model-building component 285 trains the remote model layers 286 using transformed objects generated from the training data 241.

Remote model layers 286 form a complete bifurcated neural network when combined with the local model layers 242. The remote model layers 286 comprise the subsequent layers of the full model. The remote model layers 286 may be trained by optimizing the subsequent layers in the analogous model that do not form the local model layers 242. For example, if the local model layers 242 comprise only an input layer, then the deep layers and output layer would be included in the remote model layers 286. The local model layers 242 are trained using the analogous training data 281. The remote model layers 286 comprise layers that are trained using transformed objects generated from training data 241.

Model output manager 288 receives a classification from the remote model layers 286 and communicates it to the image classification manager 252. The classification can be associated with an image in the unclassified images 250. To aid this process, the same identification may be associated with an image, a transformed object generated from the image, and a classification generated from the transformed object. In this way the classification can be associated with the original image.

Turning now to FIG. 3, the training of an analogous model 300 is depicted. The training may be performed in a data center, for example, by the model-building component 285. As mentioned, the analogous model 300 can be a starting point for a fully trained model used to classify images. The analogous model 300 shown is a convolutional deep network, but other models can be used in aspects of the invention. The analogous model 300 comprises an input layer 302,five convolutional layers (first convolutional layer 306, second convolutional layer 310, third convolutional layer 314, fourth convolutional layer 318, and fifth convolutional layer 322), and three fully connected layers (a first fully-connected layer 326, a second fully-connected layer 330, and an output layer 334). Aspects of the technology described herein are not limited to this arrangement.

The input layer converts the image into data that can be processed by the first convolutional layer 306. In one aspect, the input layer comprises three layered arrays. Each node in the array represents a pixel in the image. Each array represents either red, green, or blue. In the red array, a node can be the intensity of red associated with the node's pixel. In this way, each pixel is represented by three nodes; one in each sub-layer within the input layer. The input layer 302 does not sufficiently anonymize the image data as the image can be reproduced using the data stored in the input layer 302.

Initially, an image from analogous images 301 is processed as input. The processing occurs the same way whether in training or production mode. The only difference is that the neuron weights in the model may be changed after a classification is produced while in training mode. In this example, the image can be 224×224 pixels. The depth of input layer 302 can be described as three because each pixel can have a red, green, and blue (RGB) pixel intensity value.

The first convolution layer 306 comprises multiple sublayers, described herein as feature maps. Each feature map (i.e., sublayer) can be associated with a different filter operation. The filter operation can be described as a neuron's activation function. The goal of the filter can be to detect low-level shapes in an image, such as a curve or line. Each filter operation works on a group of pixels in the image that can be described as a receptive field 304. Each neuron in a sublayer has a different receptive filed. The output of the filter operation combined with a weight assigned to a neuron can be the neuron's output. For example, a filter operation on a 5×5×3 receptive field 304 of the input layer 302 can produce a single value. When combined with the weight of the neuron the result is the output of a single neuron in the first convolutional layer 306. This process is repeated for adjacent neurons in the feature map, which will each use a different receptive field. The process can also be repeated on the same receptive field 304 by each neuron in different feature maps within the convolutional layer using the filter operation associated with the respective feature map.

If the receptive field contains a sought after feature (e.g., a curve, honeycomb shape, a triangle) then a different number would result than if it did not. For example, a filter operation that did not find a sought after feature could return a zero value in contrast to a value of 1000 if the feature in the image exactly matched a feature in the filter.

The feature map is populated by running the same filter operation over different receptive fields of the input layer 302, eventually processing the entire input layer 302. Sections of the input layer 302 to be mapped are determined by the stride selected. The stride is a distance between center pixels of adjacent receptive fields. The adjacent receptive fields are associated with adjacent neurons. A stride of one pixel would cause the adjacent receptive field to have a center pixel adjacent to a center pixel in the first receptive field 304. A stride of two would cause the center pixel of a receptive field to move over two pixels. Aspects of the technology can be used with different strides, such as a stride of 2, 4, or 6.

The first convolutional layer 306 comprises multiple feature maps; each feature map comprising an array of neurons populated using the same filter operation. The first feature map can look for curves, the second feature map lines, the third feature map a blue color blob, and so on. Different weights can be calculated for each neuron during training. A convolutional layer with 48 feature maps can be said to have a depth of 48. The height and width dimensions will depend on the image size, receptive field size, and stride. For this example, the first convolutional layer 306 can have a height and width of 55.

Accordingly, the first convolutional layer 306 can comprise a plurality of feature maps. Each feature map can be a single dimensional array of numbers produced by a single filter operation on a group of pixels. The more filters used, the more feature maps the convolutional layer will contain. For example, using 48 filters will produce a first convolutional layer 306 having a depth of 48 different arrays. In one aspect, the first convolutional layer 306 can comprise a transformational object.

The other convolutional layers can work in a similar fashion, with a receptive field of various dimensions in a prior layer mapping to a neuron in a subsequent layer. FIG. 3 depicts a neuron in the second convolutional layer 310 having a receptive field 308 in the first convolutional layer 306, a neuron in the third convolutional layer 314 having a receptive field 312 in the second convolutional layer 310, a neuron in the fourth convolutional layer 318 having a receptive field 316 in the third convolutional layer 314, and a neuron in the fifth convolutional layer 322 having a receptive field 320 in the fourth convolutional layer 318. The functions can be of different types in different layers, for example, pooling functions, rectified linear unit operations, and such.

For example, the second convolutional layer 310 can be a pooling layer that comprises neurons arranged in feature maps that perform a down sampling operation. A purpose of the pooling layer is to reduce the amount of data to process. Each neuron in the second convolutional layer 310 has a receptive field 308 in the first convolutional layer 306. For example, a neuron could have a receptive field of 2×2 neurons meaning it processes the output of those four neurons. In a pooling operation, the highest value of the four values produced by neurons in the 2×2 grid within the receptive field 308 can be selected by the activation function of a single neuron in the second convolutional layer 310. The output of this neuron can be the highest value adjusted according to the weight, if any, assigned to the neuron.

The output of the neurons in the fifth convolutional layer 322 is fed 324 to neurons in the first fully-connected layer 326. The output of every neuron in the first fully-connected layer 326 is output 328 to every neuron in the second fully-connected layer 330. The output of every neuron in the second fully-connected layer 330 is output 332 to every neuron in the output layer 334. The output layer 334 produces a classification. In one aspect, the classification is the highest score of a classification distribution of classes being classified.

In each type of deep model, training is used to fit the model output to the training data. In particular, weights associated with each neuron in the model can be updated through training. Originally, the model can comprise random weight values that are adjusted during training. In one aspect, the model is trained using backpropagation. The backpropagation process comprises a forward pass, a loss function, a backward pass, and a weight update. This process is repeated for each training image. The goal is to update the weights of each neuron (or other model component) to cause the model to produce an output that maps to the correct label. The analogous training data comprises labeled analogous images 301. Each labeled image is input to the model and used to train it. Once a sufficient number of training images are fed to the analogous model 300, then the training can stop. The analogous model 300 can then be used to classify unlabeled images.

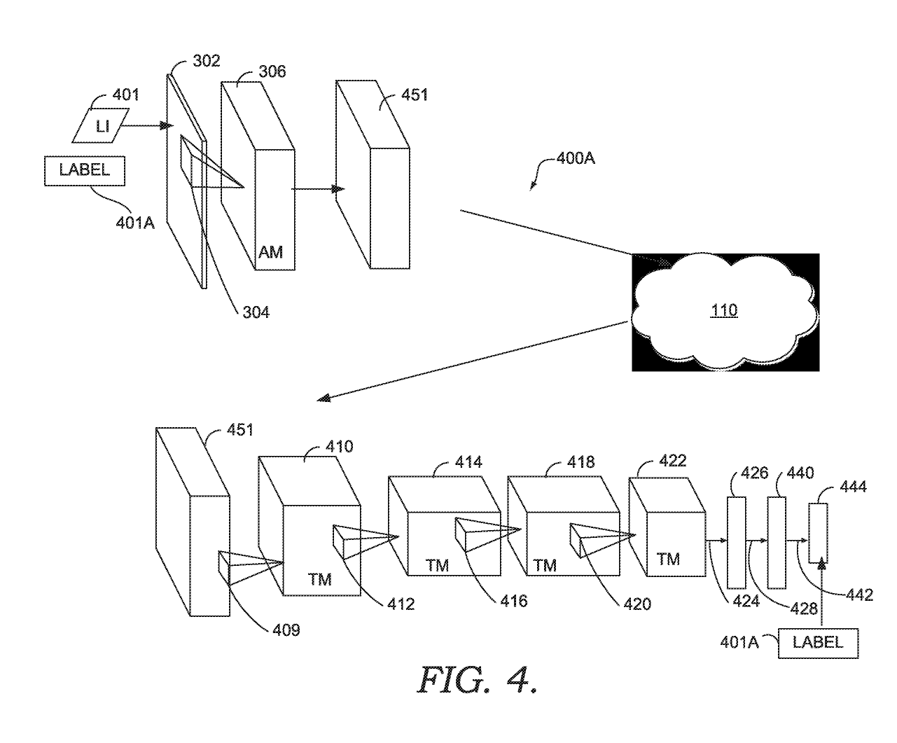

Turning now to FIG. 4, a bifurcated deep neural network 400A is trained according to an aspect of the technology described herein. The bifurcated deep neural network 400A includes the previously described input layer 302 and first convolutional layer 306. Both are located in a local computing system, such as local system 240 described previously. The weights associated with nodes in the convolutional layer are fixed after the previously described training is completed.

The remote portion of the bifurcated deep neural network 400A comprises four convolutional layers (second convolutional layer 410, third convolutional layer 414, fourth convolutional layer 418, and fifth convolutional layer 422) and three fully connected layers (a first fully-connected layer 426, a second fully-connected layer 440, and an output layer 444).

Initially, all of these layers may start with the weights previously determined for the analogous model 300. The neurons in the remote layers are then updated by additional training using actual training data that is only available in the local computing system. The bifurcated deep neural network 400A is trained while only a portion of the complete network resides in a data center without the training images leaving the local computing system.

The training begins by submitting labeled training image 401 to the input layer 302. The first convolutional layer 306 processes the image data to generate a transformed object 451. The transformed object 451 has the same dimension (e.g., 55×55×48) as the first convolution layer 306, but does not include the weights or the activation function (e.g., the filter operation). Instead, the transformed object 451 includes only the outputs of each neuron, while maintaining the correct dimensions and spatial relationship between outputs to enable feeding the values of the transformed object 451 into the correct neurons in a subsequent layer (second convolutional layer 410 in this example). Data in the transformed object can be processed by the receiving layer as it would normally be processed if received directly from the first convolutional layer 306. For example, a neuron in the second convolutional layer 410 can be mapped to a receptive area 409 within the transformed object.

The transformed object 451 effectively anonymizes the original image 401 because the image cannot be reproduced with certainty from the transformed object 451. As described with reference to FIG. 3, the operations within the first convolutional layer 306 take a group of pixels (or data representing pixels) from a receptive area and performs a calculation that can result in a single number that may describe a presence or absence of a feature, but cannot be used to reproduce the pixels in the receptive area, especially since it is combined with a weighting value. Even if the activation function and weights used to generate the neuron output were known (and they are not included in the transformed object), it would still be difficult to reverse engineer the pixels in the receptive area as different arrangements of pixels can conceivably produce the same output number from a neuron. This means multiple pixel arrangements that fit the output could exist making it impossible to ascertain the correct arrangement.

The transformed object 451 and the label 401A are communicated over the network 110 to the data center.

Once the data from the transformed object is received by neurons in the second convolutional layer 410, the network 400A operates as described previously to generate a classification for the image. FIG. 4 depicts a neuron in the third convolutional layer 414 having a receptive field 412 in the second convolutional layer 410, a neuron in the fourth convolutional layer 418 having a receptive field 416 in the third convolutional layer 414, and a neuron in the fifth convolutional layer 422 having a receptive field 420 in the fourth convolutional layer 418. The output of the neurons in the fifth convolutional layer 422 is fed 424 to neurons in the first fully-connected layer 426. The output of every neuron in the first fully-connected layer 426 is output 428 to every neuron in the second fully-connected layer 440. The output of every neuron in the second fully-connected layer 440 is output 442 to every neuron in the output layer 444. The output layer 444 produces a classification. In one aspect, the classification is the highest score of a classification distribution of classes being classified.

The classification is then compared with the label 401A, and the remote portion of the network 400A is retrained using back propagation or some other training method suitable the architecture of the network 400A. In other words, the weights associated with neurons in the four convolutional layers (second convolutional layer 410, third convolutional layer 414, fourth convolutional layer 418, and fifth convolutional layer 422) and three fully connected layers (a first fully-connected layer 426, a second fully-connected layer 440, and an output layer 444) can be updated. This process repeats with multiple training images until the remote portion is trained (designated as “TM” in FIG. 4) at which point the neuron weights can be fixed. Notice that the training does not extend back to the local portion of the model in this example, which remains the same as when trained by the analogous training data (designated “AM”).

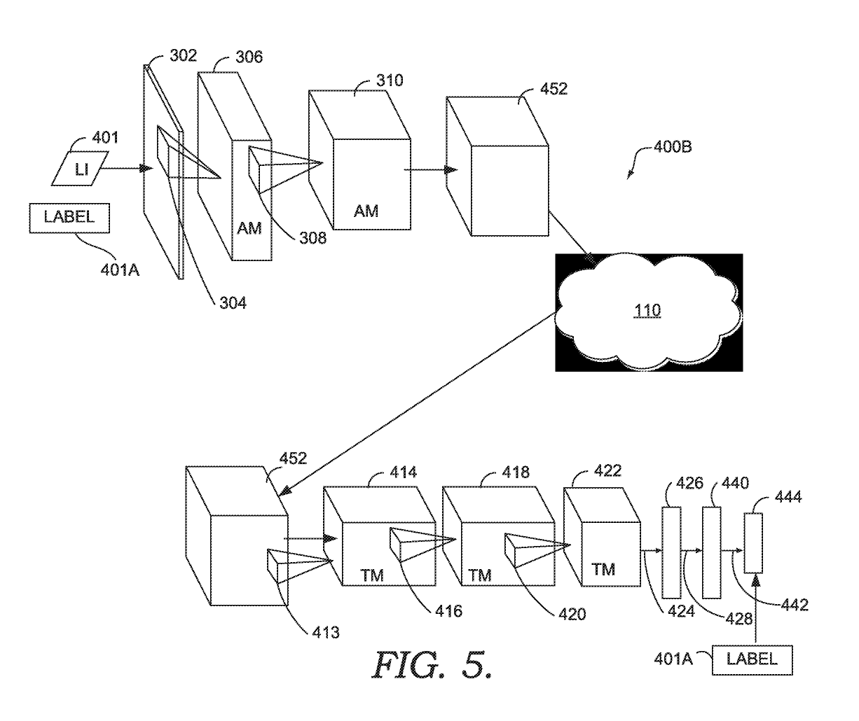

Turning now to FIG. 5, a bifurcated deep neural network 400B is trained according to an aspect of the technology described herein. The bifurcated deep neural network 400B includes the previously described input layer 302, first convolutional layer 306, and second convolutional layer 310. These three layers are located in a local computing system, such as local system 240 described previously. The weights associated with nodes in the convolutional layer are fixed after the previously described training is completed.

The remote portion of the bifurcated deep neural network 400B comprises three convolutional layers (third convolutional layer 414, fourth convolutional layer 418, and fifth convolutional layer 422) and three fully connected layers (a first fully-connected layer 426, a second fully-connected layer 440, and an output layer 444).

Initially, all of these layers may start with the weights previously determined for the analogous model 300. The neurons in the remote layers are then updated by additional training using actual training data that is only available in the local computing system. The bifurcated deep neural network 400B is trained while only a portion of the complete network resides in a data center without the training images leaving the local computing system.

The training begins by submitting labeled training image 401 to the input layer 302. The first convolutional layer 306 and second convolutional layer 310 process the image data to generate a transformed object 452. The transformed object 452 has the same dimension as the second convolutional layer 310, but does not include the weights or the activation function (e.g., the filter operation). Instead, the transformed object 452 includes only the outputs of each neuron, while maintaining the correct dimensions and spatial relationship between outputs to enable feeding the values of the transformed object 452 into the correct neurons in a subsequent layer (third convolutional layer 414 in this example). Data in the transformed object can be processed by the receiving layer as it would normally be processed if received directly from the second convolutional layer 310. For example, a neuron in the third convolutional layer 414 can be mapped to a receptive area 413 within the transformed object.

The transformed object 452 and the label 401A are communicated over the network 110 to the data center.

Once the data from the transformed object is received by neurons in the third convolutional layer 414, the remote portion of the network 400B operates as described previously to generate a classification for the image. FIG. 5 depicts a neuron in the fourth convolutional layer 418 having a receptive field 416 in the third convolutional layer 414, and a neuron in the fifth convolutional layer 422 having a receptive field 420 in the fourth convolutional layer 418. The output of the neurons in the fifth convolutional layer 422 is fed 424 to neurons in the first fully-connected layer 426. The output of every neuron in the first fully-connected layer 426 is output 428 to every neuron in the second fully-connected layer 440. The output of every neuron in the second fully-connected layer 440 is output 442 to every neuron in the output layer 444. The output layer 444 produces a classification. In one aspect, the classification is the highest score of a classification distribution of classes being classified.

The classification is then compared with the label 401A, and the remote portion of the network 400B is retrained using back propagation or some other training method suitable the architecture of the network 400B. In other words, the weights associated with neurons in the four convolutional layers (second convolutional layer 310, third convolutional layer 414, fourth convolutional layer 418, and fifth convolutional layer 422) and three fully connected layers (a first fully-connected layer 426, a second fully-connected layer 440, and an output layer 444) can be updated. This process repeats with multiple training images until the remote portion is trained (designated as “TM” in FIG. 4) at which point the neuron weights can be fixed. Notice that the training does not extend back to the local portion of the model in this example, which remains the same as when trained by the analogous training data (designated “AM”).

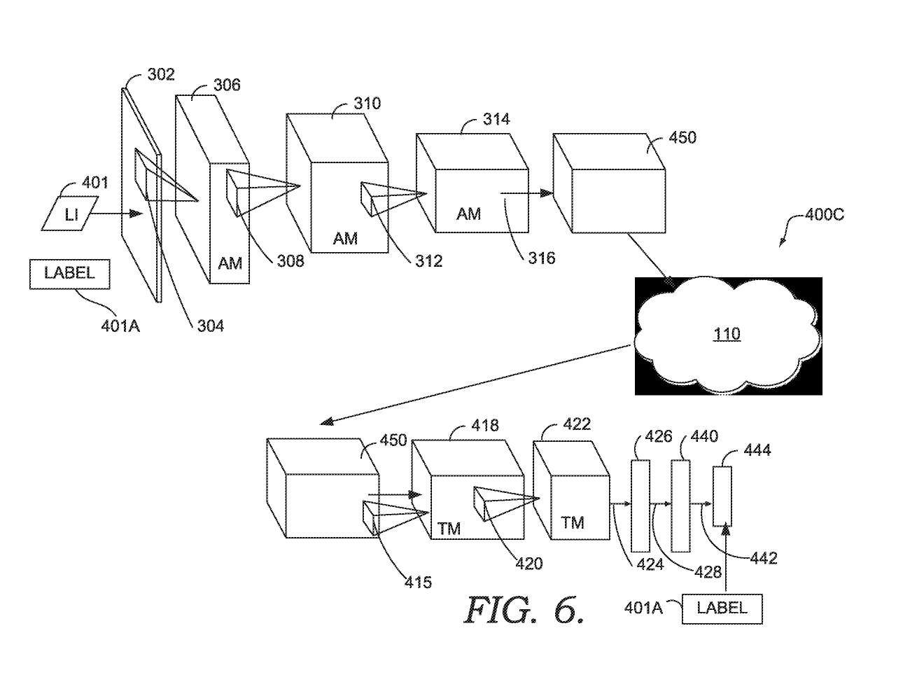

Turning now to FIG. 6, a bifurcated deep neural network 400C is trained according to an aspect of the technology described herein. The bifurcated deep neural network 400C includes the previously described input layer 302, first convolutional layer 306, second convolutional layer 310, and third convolutional layer 314. These four layers are located in a local computing system, such as local system 240 described previously. The weights associated with nodes in the convolutional layer are fixed after the previously described training is completed.

The remote portion of the bifurcated deep neural network 400C comprises two convolutional layers (fourth convolutional layer 418 and fifth convolutional layer 422) and three fully connected layers (a first fully-connected layer 426, a second fully-connected layer 440, and an output layer 444).

Initially, all of these layers may start with the weights previously determined for the analogous model 300. The neurons in the remote layers are then updated by additional training using actual training data that is only available in the local computing system. The bifurcated deep neural network 400C is trained while only a portion of the complete network resides in a data center without the training images leaving the local computing system.

The training begins by submitting a labeled training image 401 to the input layer 302. The first convolutional layer 306, second convolutional layer 310, and third convolutional layer 314 process the image data to generate a transformed object 450. The transformed object 450 has the same dimension as the third convolutional layer 314, but does not include the weights or the activation function (e.g., the filter operation). Instead, the transformed object 450 includes only the outputs of each neuron, while maintaining the correct dimensions and spatial relationship between outputs to enable feeding the values of the transformed object 450 into the correct neurons in a subsequent layer (fourth convolutional layer 418 in this example). Data in the transformed object can be processed by the receiving layer as it would normally be processed if received directly from the second convolutional layer 310. For example, a neuron in the fourth convolutional layer 418 can be mapped to a receptive area 415 within the transformed object.

The transformed object 450 and the label 401A are communicated over the network 110 to the data center.

Once the data from the transformed object is received by neurons in the fourth convolutional layer 418, the remote portion of the network 400C operates as described previously to generate a classification for the image. FIG. 6 depicts a neuron in the fifth convolutional layer 422 having a receptive field 420 in the fourth convolutional layer 418. The output of the neurons in the fifth convolutional layer 422 is fed 424 to neurons in the first fully-connected layer 426. The output of every neuron in the first fully-connected layer 426 is output 428 to every neuron in the second fully-connected layer 440. The output of every neuron in the second fully-connected layer 440 is output 442 to every neuron in the output layer 444. The output layer 444 produces a classification. In one aspect, the classification is the highest score of a classification distribution of classes being classified.

The classification is then compared with the label 401A, and the remote portion of the network 400C is retrained using back propagation or some other training method suitable to the architecture of the network 400C. In other words, the weights associated with neurons in the four convolutional layers (second convolutional layer 410, third convolutional layer 414, fourth convolutional layer 418, and fifth convolutional layer 422) and three fully connected layers (a first fully-connected layer 426, a second fully-connected layer 440, and an output layer 444) can be updated. This process repeats with multiple training images until the remote portion is trained (designated as “TM” in FIG. 4) at which point the neuron weights can be fixed. Notice that the training does not extend back to the local portion of the model in this example, which remains the same as when trained by the analogous training data (designated “AM”).

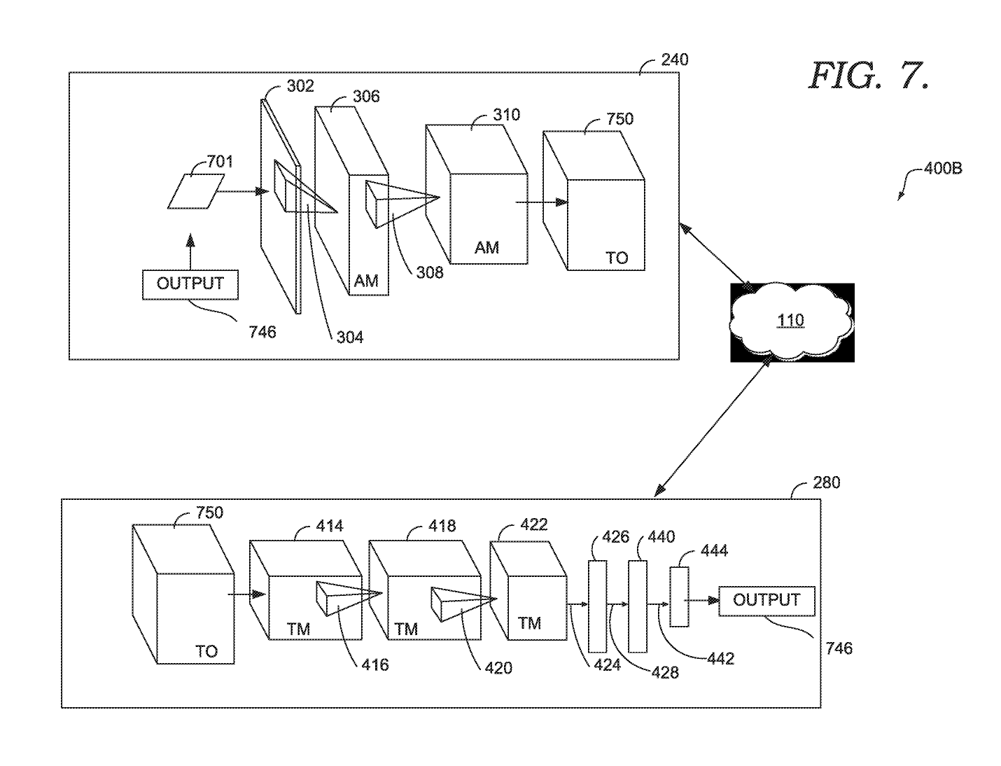

Turning now to FIG. 7, use of a bifurcated neural network 400B to classify an image is demonstrated according to an aspect of the technology described herein. This network 400B was described previously with reference to FIG. 5 when training was described. The local portion of the bifurcated network resides on the local system 240. The remote portion resides on the remote system 280. The local portion includes the previously described input layer 302, first convolutional layer 306, and second convolutional layer 310. The weights associated with nodes in these convolutional layers are fixed after the previously described training on analogous data is completed.

The remote portion of the bifurcated deep neural network 400B comprises three convolutional layers (third convolutional layer 414, fourth convolutional layer 418, and fifth convolutional layer 422) and three fully connected layers (a first fully-connected layer 426, a second fully-connected layer 440, and an output layer 444) all residing on the remote system 280.

The classification process begins by submitting image 701 to the input layer 302. The first convolutional layer 306 and second convolutional layer 310 process the image data to generate a transformed object 750. The transformed object 750 has the same dimension as the second convolutional layer 310, but does not include the weights or the activation function (e.g., the filter operation). The transformed object 750 is communicated over the network 110 to the remote system 280.

Once the data from the transformed object 750 is received by neurons in the third convolutional layer 414, the remote portion of the network 400B operates as described previously to generate a classification for the image. FIG. 7 depicts a neuron in the fourth convolutional layer 418 having a receptive field 416 in the third convolutional layer 414, and a neuron in the fifth convolutional layer 422 having a receptive field 420 in the fourth convolutional layer 418. The output of the neurons in the fifth convolutional layer 422 is fed 424 to neurons in the first fully-connected layer 426. The output of every neuron in the first fully-connected layer 426 is output 428 to every neuron in the second fully-connected layer 440. The output of every neuron in the second fully-connected layer 440 is output 442 to every neuron in the output layer 444. The output layer 444 produces a classification 746. In one aspect, the classification is the highest score of a classification distribution of classes being classified. The classification 746 is then communicated back to the local system 240 where it is associated with the image 701.

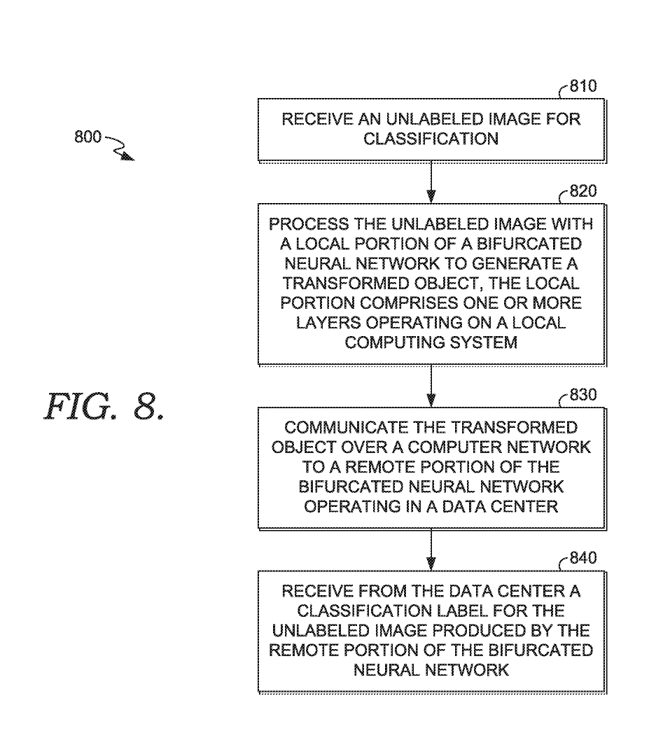

Turning now to FIG. 8, a flow chart showing a method 800 of anonymizing image data is provided. At step 810, an unlabeled image is received for classification. The unlabeled image can be a digital image containing a visual depiction of an object or objects to be classified. The image is unlabeled from the perspective of a deep neural network because any label associated with the image is not communicated to the deep neural network. An unlabeled image can be contrasted with a labeled image used for training a deep neural network. A labeled image is often viewed by a person who adds labels to the image describing objects depicted in the image. The unlabeled image may be associated with meta-data, including various labels, but if any classification has been made it is not communicated to the local portion of a bifurcated network.

At step 820, the unlabeled image is processed with a local portion of a bifurcated neural network to generate a transformed object. The local portion comprises one or more layers operating on a local computing system, for example, as described previously with reference to FIGS. 4-7. In one aspect, the local portion comprises an input layer and one or more convolutional layers.

The transformed object effectively anonymizes the unlabeled image because the image cannot be reproduced with certainty from the transformed object. As described with reference to FIG. 3, the operations within a convolutional layer take a group of pixels (or data representing pixels) from a receptive area and perform a calculation that can result in a single number that may describe a presence or absence of a feature, but cannot be used to reproduce the pixels in the receptive area, especially since it is combined with a weighting value. Even if the activation function and weights used to generate the neuron output were known (and they are not included in the transformed object), it would still be difficult to reverse engineer the pixels in the receptive area as different arrangements of pixels can conceivably produce the same output number from a neuron. This means multiple pixel arrangements that fit the output could exist, making it impossible to ascertain the correct arrangement.

The transformed object has the same dimension (e.g., 55×55×48) as the layer from which the transformed object was extracted, but does not include the weights or the activation function used by the neurons (e.g., the filter operation). Instead, the transformed object includes the outputs of each neuron in a layer, while maintaining the correct dimensions and spatial relationship between outputs to enable feeding the values of the transformed object into the correct neurons in a subsequent layer in the data center. Data in the transformed object can be processed by the receiving layer as it would normally be processed if received directly from the convolutional layer.

At step 830, the transformed object is communicated over a computer network to a remote portion of the bifurcated neural network operating in a data center. The transformed object is then processed by the remote portion of the bifurcated neural network to generate a classification for the unlabeled image.

At step 840, a classification label for the unlabeled image produced by the remote portion of the bifurcated neural network is received from the data center. The classification is then associated with the unlabeled image by the local computing system.

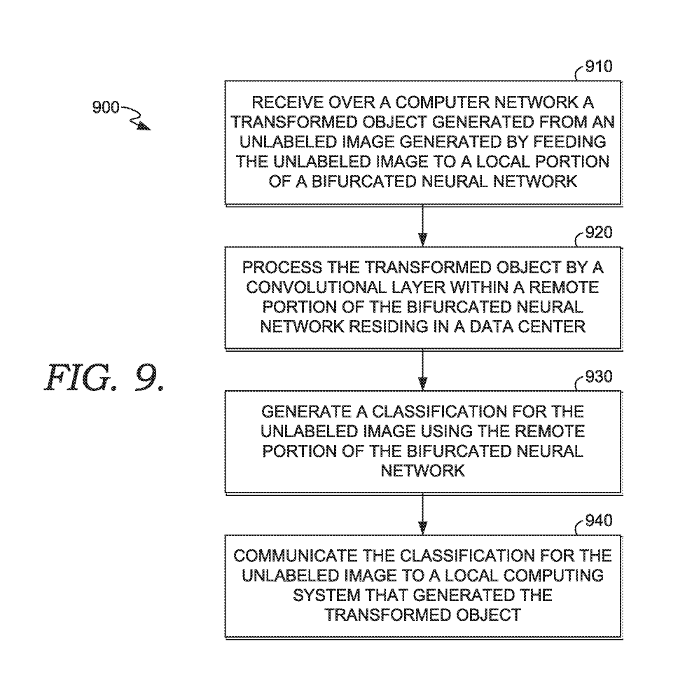

Turning now to FIG. 9, a flow chart showing a method 900 of anonymizing image data is provided. At step 910, a transformed object is received over a computer network. The transformed object is generated from an unlabeled image generated by feeding the unlabeled image to a local portion of a bifurcated neural network.

The transformed object effectively anonymizes the unlabeled image because the image cannot be reproduced with certainty from the transformed object. As described with reference to FIG. 3, the operations within a convolutional layer take a group of pixels (or data representing pixels) from a receptive area and perform a calculation that can result in a single number that may describe a presence or absence of a feature, but cannot be used to reproduce the pixels in the receptive area, especially since it is combined with a weighting value. Even if the activation function and weights used to generate the neuron output were known (and they are not included in the transformed object), it would still be difficult to reverse engineer the pixels in the receptive area as different arrangements of pixels can conceivably produce the same output number from a neuron. This means multiple pixel arrangements that fit the output could exist, making it impossible to ascertain the correct arrangement.

The transformed object has the same dimension (e.g., 55×55×48) as the layer from which the transformed object was extracted, but does not include the weights or the activation function used by the neurons (e.g., the filter operation). Instead, the transformed object includes the outputs of each neuron in a layer, while maintaining the correct dimensions and spatial relationship between outputs to enable feeding the values of the transformed object into the correct neurons in a subsequent layer in the data center. Data in the transformed object can be processed by the receiving layer as it would normally be processed if received directly from the convolutional layer.

At step 920, the transformed object is processed by a convolutional layer within a remote portion of the bifurcated neural network residing in a data center, as described previously with reference to FIGS. 4-7.

At step 930, a classification is generated for the unlabeled image using the remote portion of the bifurcated neural network, as described previously with reference to FIGS. 4-7.

At step 940, the classification for the unlabeled image is communicated to a local computing system that generated the transformed object, as described previously with reference to FIGS. 4-7.

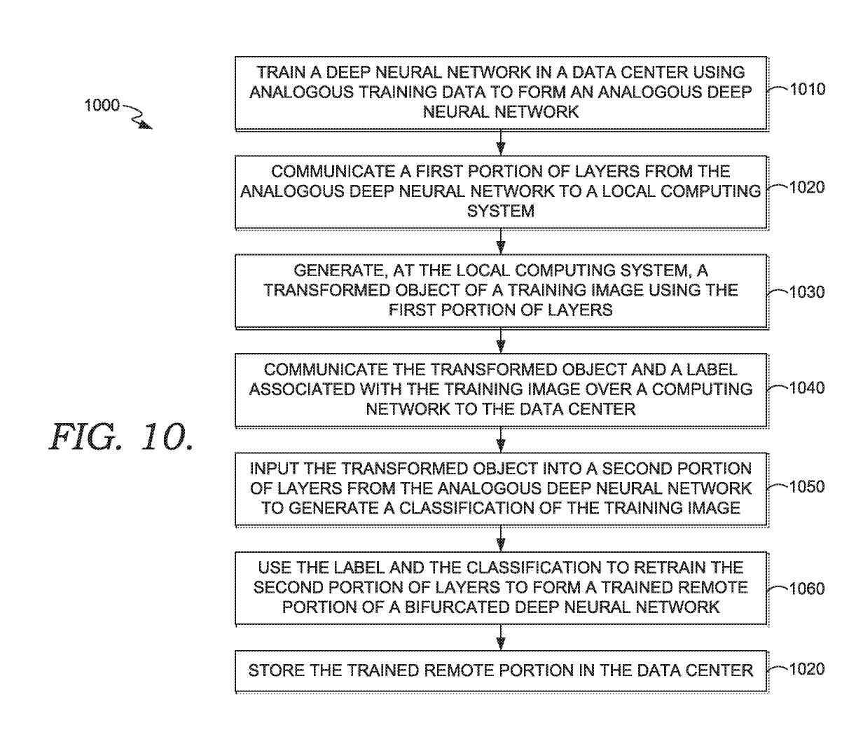

Turning now to FIG. 10, a flow chart showing a method 1000 of anonymizing image data is provided. At step 1010, a deep neural network is trained in a data center using analogous training data to form an analogous deep neural network, as described previously with reference to FIG. 3.

At step 1020, a first portion of layers from the analogous deep neural network is communicated to a local computing system. For example, the first portion can include an input layer and one or more convolutional layers.

At step 1030, a transformed object of a training image is generated at the local computing system using the first portion of layers. The transformed object effectively anonymizes the unlabeled image because the image cannot be reproduced with certainty from the transformed object. As described with reference to FIG. 3, the operations within a convolutional layer take a group of pixels (or data representing pixels) from a receptive area and perform a calculation that can result in a single number that may describe a presence or absence of a feature, but cannot be used to reproduce the pixels in the receptive area, especially since it is combined with a weighting value. Even if the activation function and weights used to generate the neuron output were known (and they are not included in the transformed object), it would still be difficult to reverse engineer the pixels in the receptive area as different arrangements of pixels can conceivably produce the same output number from a neuron. This means multiple pixel arrangements that fit the output could exist, making it impossible to ascertain the correct arrangement.

The transformed object has the same dimension (e.g., 55×55×48) as the layer from which the transformed object was extracted, but does not include the weights or the activation function used by the neurons (e.g., the filter operation). Instead, the transformed object includes the outputs of each neuron in a layer, while maintaining the correct dimensions and spatial relationship between outputs to enable feeding the values of the transformed object into the correct neurons in a subsequent layer in the data center. Data in the transformed object can be processed by the receiving layer as it would normally be processed if received directly from the convolutional layer.

At step 1040, the transformed object and a label associated with the training image are communicated over a computing network to the data center, as described previously with reference to FIGS. 4-6.

At step 1050, the transformed object is input into a second portion of layers from the analogous deep neural network to generate a classification of the training image, as described previously with reference to FIGS. 4-6.

At step 1060, the label and the classification are used to retrain the second portion of layers to form a trained remote portion of a bifurcated deep neural network, as described previously with reference to FIGS. 4-6.

At step 1070, the trained remote portion is stored in the data center. The trained remote portion can then be used to classify unlabeled images in response to receiving a transformed object from a local system, as described previously with reference to FIG. 7.

### Exemplary Operating Environment

Referring to the drawings in general, and to FIG. 11 in particular, an exemplary operating environment for implementing aspects of the technology described herein is shown and designated generally as computing device 1100. Computing device 1100 is but one example of a suitable computing environment and is not intended to suggest any limitation as to the scope of use of the technology described herein. Neither should the computing device 1100 be interpreted as having any dependency or requirement relating to any one or combination of components illustrated.

The technology described herein may be described in the general context of computer code or machine-useable instructions, including computer-executable instructions such as program components, being executed by a computer or other machine, such as a personal data assistant or other handheld device. Generally, program components, including routines, programs, objects, components, data structures, and the like, refer to code that performs particular tasks or implements particular abstract data types. The technology described herein may be practiced in a variety of system configurations, including data center based servers, handheld devices, consumer electronics, general-purpose computers, specialty computing devices, etc. Aspects of the technology described herein may also be practiced in distributed computing environments where tasks are performed by remote-processing devices that are linked through a communications network.

With continued reference to FIG. 11, computing device 1100 includes a bus 1110 that directly or indirectly couples the following devices: memory 1112, one or more processors 1114, one or more presentation components 1116, input/output (I/O) ports 1118, I/O components 1120, and an illustrative power supply 1122. Bus 1110 represents what may be one or more busses (such as an address bus, data bus, or a combination thereof). Although the various blocks of FIG. 11 are shown with lines for the sake of clarity, in reality, delineating various components is not so clear, and metaphorically, the lines would more accurately be grey and fuzzy. For example, one may consider a presentation component such as a display device to be an I/O component. Also, processors have memory. The inventors hereof recognize that such is the nature of the art and reiterate that the diagram of FIG. 11 is merely illustrative of an exemplary computing device that can be used in connection with one or more aspects of the technology described herein. Distinction is not made between such categories as “workstation,” “server,” “laptop,” “handheld device,” etc., as all are contemplated within the scope of FIG. 11 and refer to “computer” or “computing device.”

Computing device 1100 typically includes a variety of computer-readable media. Computer-readable media can be any available media that can be accessed by computing device 1100 and includes both volatile and nonvolatile media, removable and non-removable media. By way of example, and not limitation, computer-readable media may comprise computer storage media and communication media. Computer storage media includes both volatile and nonvolatile, removable and non-removable media implemented in any method or technology for storage of information such as computer-readable instructions, data structures, program modules, or other data.

Computer storage media includes RAM, ROM, EEPROM, flash memory or other memory technology, CD-ROM, digital versatile disks (DVD) or other optical disk storage, magnetic cassettes, magnetic tape, magnetic disk storage or other magnetic storage devices. Computer storage media does not comprise a propagated data signal.

Communication media typically embodies computer-readable instructions, data structures, program modules, or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared, and other wireless media. Combinations of any of the above should also be included within the scope of computer-readable media.

Memory 1112 includes computer storage media in the form of volatile and/or nonvolatile memory. The memory 1112 may be removable, non-removable, or a combination thereof Exemplary memory includes solid-state memory, hard drives, optical-disc drives, etc. Computing device 1100 includes one or more processors 1114 that read data from various entities such as bus 1110, memory 1112, or I/O components 1120. Presentation component(s) 1116 present data indications to a user or other device. Exemplary presentation components 1116 include a display device, speaker, printing component, vibrating component, etc. I/O ports 1118 allow computing device 1100 to be logically coupled to other devices, including I/O components 1120, some of which may be built in.

Illustrative I/O components include a microphone, joystick, game pad, satellite dish, scanner, printer, display device, wireless device, a controller (such as a stylus, a keyboard, and a mouse), a natural user interface (NUI), and the like. In aspects, a pen digitizer (not shown) and accompanying input instrument (also not shown but which may include, by way of example only, a pen or a stylus) are provided in order to digitally capture freehand user input. The connection between the pen digitizer and processor(s) 1114 may be direct or via a coupling utilizing a serial port, parallel port, and/or other interface and/or system bus known in the art. Furthermore, the digitizer input component may be a component separated from an output component such as a display device, or in some aspects, the useable input area of a digitizer may coexist with the display area of a display device, be integrated with the display device, or may exist as a separate device overlaying or otherwise appended to a display device. Any and all such variations, and any combination thereof, are contemplated to be within the scope of aspects of the technology described herein.

An NUI processes air gestures, voice, or other physiological inputs generated by a user. Appropriate NUI inputs may be interpreted as ink strokes for presentation in association with the computing device 1100. These requests may be transmitted to the appropriate network element for further processing. An NUI implements any combination of speech recognition, touch and stylus recognition, facial recognition, biometric recognition, gesture recognition both on screen and adjacent to the screen, air gestures, head and eye tracking, and touch recognition associated with displays on the computing device 1100. The computing device 1100 may be equipped with depth cameras, such as stereoscopic camera systems, infrared camera systems, RGB camera systems, and combinations of these, for gesture detection and recognition. Additionally, the computing device 1100 may be equipped with accelerometers or gyroscopes that enable detection of motion. The output of the accelerometers or gyroscopes may be provided to the display of the computing device 1100 to render immersive augmented reality or virtual reality.

A computing device may include a radio 1124. The radio 1124 transmits and receives radio communications. The computing device may be a wireless terminal adapted to receive communications and media over various wireless networks. Computing device 1100 may communicate via wireless protocols, such as code division multiple access (“CDMA”), global system for mobiles (“GSM”), or time division multiple access (“TDMA”), as well as others, to communicate with other devices. The radio communications may be a short-range connection, a long-range connection, or a combination of both a short-range and a long-range wireless telecommunications connection. When we refer to “short” and “long” types of connections, we do not mean to refer to the spatial relation between two devices. Instead, we are generally referring to short range and long range as different categories, or types, of connections (i.e., a primary connection and a secondary connection). A short-range connection may include a Wi-Fi® connection to a device (e.g., mobile hotspot) that provides access to a wireless communications network, such as a WLAN connection using the 802.11 protocol. A Bluetooth connection to another computing device is a second example of a short-range connection. A long-range connection may include a connection using one or more of CDMA, GPRS, GSM, TDMA, and 802.16 protocols.

Many different arrangements of the various components depicted, as well as components not shown, are possible without departing from the scope of the claims below. Aspects of the present technology have been described with the intent to be illustrative rather than restrictive. Alternative aspects will become apparent to readers of this disclosure after and because of reading it. Alternative means of implementing the aforementioned can be completed without departing from the scope of the claims below. Certain features and sub-combinations are of utility and may be employed without reference to other features and sub-combinations and are contemplated within the scope of the claims.

What is claimed is:

1. A method of anonymizing image data comprising:
receiving an unlabeled image for classification;
processing the unlabeled image with a local portion of a bifurcated neural network to generate a transformed object, the local portion comprising one or more layers operating on a local computing system;
communicating the transformed object over a computer network to a remote portion of the bifurcated neural network operating in a data center; and
receiving from the data center a classification label for the unlabeled image produced by the remote portion of the bifurcated neural network.

2. The method of claim 1, wherein a layer in the local portion of the bifurcated neural network that produced the transformed object is trained in a data center on labeled analogous images.

3. The method of claim 2, wherein each layer of the remote portion of the bifurcated neural network is trained on transformed objects generated by the local portion by processing labeled training images, wherein the labeled training images have more visual similarity with the unlabeled image than the analogous images.

4. The method of claim 1, wherein the local portion of the bifurcated neural network comprises a convolutional layer.

5. The method of claim 1, wherein the local portion of the bifurcated neural network comprises a convolutional pooling layer.

6. The method of claim 5, wherein the transformed object comprises an output from each neuron in the convolutional pooling layer.

7. The method of claim 1, wherein the transformed object does not comprise an activation function or weight for a neuron in any of the one or more layers operating on the local computing system.

8. A method for anonymizing image data comprising:
receiving over a computer network a transformed object generated from an unlabeled image generated by feeding the unlabeled image to a local portion of a bifurcated neural network;
processing the transformed object by a convolutional layer within a remote portion of the bifurcated neural network residing in a data center;
generating a classification for the unlabeled image using the remote portion of the bifurcated neural network; and
communicating the classification for the unlabeled image to a local computing system that generated the transformed object.

9. The method of claim 8, wherein the transformed object comprises an output from each neuron of a layer in the local portion of the bifurcated neural network.

10. The method of claim 9, wherein the transformed object does not comprise an activation function or node weights of neurons in the layer.

11. The method of claim 9, wherein the layer is a convolutional layer.

12. The method of claim 9, wherein the layer is a convolutional pooling layer.

13. The method of claim 8, wherein the unlabeled image, the transformed object, and the classification are all associated with a common identification.

14. The method of claim 8, wherein the remote portion of the bifurcated neural network is trained using transformed objects received from the local portion of the bifurcated neural network.

15. The method of claim 8, wherein the remote portion of the bifurcated neural network runs on multiple graphic processing units within the data center.

16. A computer-storage media having computer-executable instructions embodied thereon that when executed by a computer processor causes a mobile computing device to perform a method of anonymizing image data comprising, the method comprising:
training a deep neural network in a data center using analogous training data to form an analogous deep neural network;
communicating a first portion of layers from the analogous deep neural network to a local computing system;
generating, at the local computing system, a transformed object of a training image using the first portion of layers;
communicating the transformed object and a label associated with the training image over a computing network to the data center;
inputting the transformed object into a second portion of layers from the analogous deep neural network to generate a classification of the training image;
using the label and the classification to retrain the second portion of layers to form a trained remote portion of a bifurcated deep neural network; and
storing the trained remote portion in the data center.

17. The media of claim 16, wherein the transformed object comprises an output from each neuron of a layer in the first portion of layers.

18. The media of claim 17, wherein the transformed object does not comprise an activation function or node weights of neurons in the layer.

19. The media of claim 17, wherein the layer is a convolutional layer.

20. The media of claim 16, wherein the remote portion runs on multiple graphic processing units within the data center.
